(19) United States
(12) Patent Application Publication
(10) Pub. No.: US 2003/0013461 A1
(43) Pub. Date: Jan. 16, 2003

(54) Mobile telephone device

(76) Inventors: Masahito Mizune, Tottori-Shi (JP); Susumu Iida, Tottori-Shi (JP)

Correspondence Address: David T. Nikaido, RADER, FISHMAN & GRAUER, PLLC, Suite 501, 1233 20th Street NW, Washington, DC, 20036, US

(21) Appl. No.: 10/193,904

(22) Filed: Jul. 15, 2002

(30) Foreign Application Priority Data
Jul. 16, 2001 (JP) 2001-215414
Jul. 31, 2001 (JP) 2001-230864

(51) Int. Cl. H04Q 7/20

(52) U.S. Cl. 455/456; 455/457

(57) ABSTRACT

A mobile telephone device has a location detector for detecting the location information of the mobile telephone device itself, a receiver for receiving the location information of the communication partner device, a direction sensor, and a direction calculator for calculating the direction of the communication partner device relative to the mobile telephone device based on the location information of the two devices. The direction of the communication partner device is displayed against a background coinciding with the bearing detected by the direction sensor. This configuration permits the location of a communication partner to be indicated in an easy-to-grasp way even with a small display. Moreover, the mobile telephone device indicates the location of a communication partner before responding to a call. This configuration permits a call receiver to decide whether to respond to a call or not after identifying the location of a call originator.

### BACKGROUND OF THE INVENTION

1. Field of the Invention

The present invention relates to a mobile telephone device.

2. Description of the Prior Art

For a conventional wired telephone system comprising wired telephone devices and line switching machines, a technique has been proposed that permits, when a call originator is connected to a call receiver, the call receiver to be notified of the current location of the call originator (i.e. the location at which the wired telephone device that the call originator is using is installed) by a line switching machine. This is achieved by storing, in line switching machines, the locations of the individual wired telephone devices when their users sign up for telephony services (see the publication of Japanese Patent Application Laid-Open No. S61-169060). In recent years, this technique of notifying a call receiver of the current location of a call originator is applied also to a mobile telephone system that employs, as terminal devices, mobile telephone devices, of which the current location is unpredictable. In this case, mobile telephone devices are equipped with a means for detecting their current location, such as a GPS (global positioning system) receiver. A mobile telephone device ready for this service has a display, such as a liquid crystal display, so that the current location of a call originator is shown on a map displayed on the display.

To be sure, by using a mobile telephone device configured as described above, a call receiver, when connected to the call originator, can know the current location of the call originator. However, mobile telephone devices configured as described above have small displays, and small memories for storage of maps, and therefore with them it has been difficult to display the current location of a call originator in an easy-to-view way. Moreover, the aforementioned technique of notifying a call receiver of the current location of a call originator disclosed in Japanese Patent Application Laid-Open No. S61-169060 permits the current location of the call originator to be indicated only after the call receiver has responded to a call. Thus, this technique, if applied unmodified to a mobile telephone system, does not permit a call receiver to first identify the current location of a call originator and then decide whether to respond to a call or not. Accordingly, even when a call originator happens to be nearby a call receiver, the call receiver, unaware of the situation, often responds to a call, which turns out to be unnecessary.

### SUMMARY OF THE INVENTION

A first object of the present invention is to provide a mobile telephone device that can indicate the current location of a communication partner in a easy-to-grasp way. A second object of the present invention is to provide a mobile telephone device that permits a call receiver to decide whether to respond to a call or not after identifying the current location of a call originator.

To achieve the first object above, according to the present invention, a mobile telephone device is provided with: a communicator for controlling the origination and reception of a call to and from a communication partner device; a display for displaying information on a screen; a location detector for detecting the location information of the mobile telephone device itself; a receiver for receiving the location information of the communication partner device; a direction sensor for detecting the bearing of the mobile telephone device; and a direction calculator for calculating the direction of the communication partner device relative to the mobile telephone device based on the location information of the mobile telephone device and of the communication partner device,. Here, the direction of the communication partner device relative to the mobile telephone device is displayed on the display against a background coinciding with the bearing detected by the direction sensor.

To achieve the second object above, according to the present invention, a mobile telephone device is provided with: a communicator for controlling the origination and reception of a call to and from a communication partner device; a receiver for receiving the location information of the communication partner device when the mobile telephone device receives a call; and an indicator for indicating information. Here, the indicator indicates the location information of the communication partner device before the mobile telephone device responds to the call.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a block diagram showing a mobile telephone device embodying the invention;

FIG. 2 is a diagram showing an example of the communications system in which the embodiment operates;

FIG. 3 is a time chart showing how communication proceeds between a calling terminal A, a called terminal B, and a base station C;

FIG. 4 is a diagram showing an example of what is displayed on the display 14; and

FIG. 5 is a diagram showing another example of what is displayed on the display 14.

### DESCRIPTION OF THE PREFERRED EMBODIMENTS

Hereinafter, an embodiment of the present invention will be described with reference to the drawings. In this embodiment, it is assumed that the mobile telephone devices used by a call originator and by a call receiver are both of a type that adopts CDMA (code division multiple access), a communication scheme that permits the use of a plurality of carriers having an identical frequency within an identical cell.

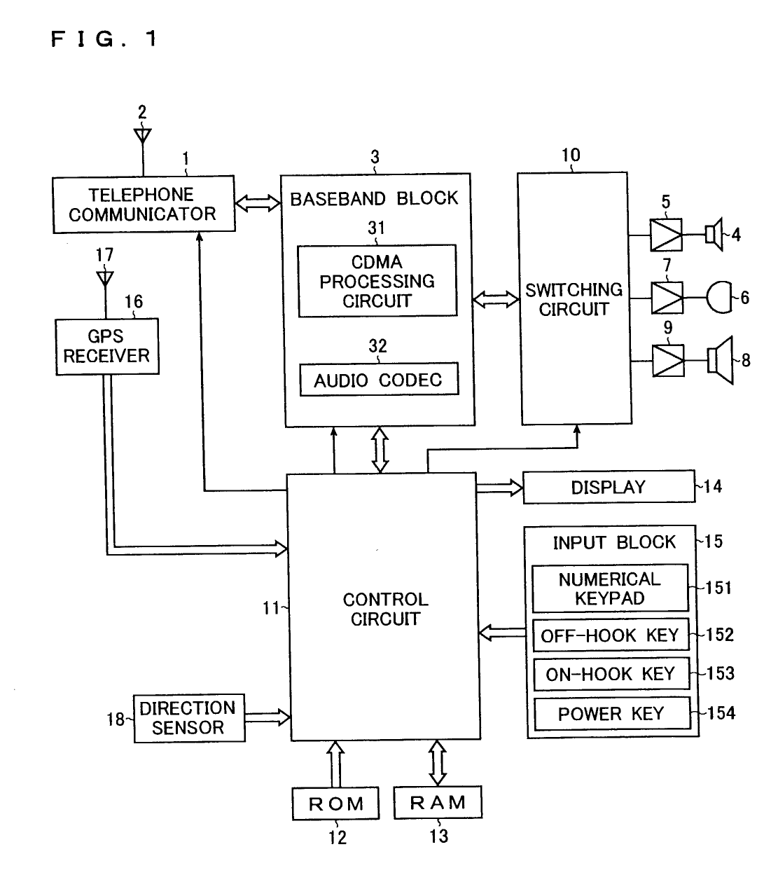

FIG. 1 is a block diagram showing a mobile telephone device embodying the invention. A telephone communicator 1, on one hand, transmits a signal from a baseband block 3 through an antenna 2 to a base station (not shown) and, on the other hand, receives a radio wave from a base station through the antenna 2.

The baseband block 3 includes a CDMA processing circuit 31 and an audio codec 32, and controls the operation of these circuits 31 and 32 according to instructions from a control circuit 11, which will be described later. The CDMA processing circuit 31 takes care of connection based on code division multiple access, scrambling, error handling, and timing detection. The audio codec 32 takes care of compression (encoding) and decompression (decoding) of voice, conversion between analog and digital signals, and adjustment of received voice volume and of microphone sensitivity through control of amplifier circuits (not shown) provided internally.

A speaker 4 serves as an earpiece, which the user puts to his or her ear to hear the received voice during a call. The speaker 4 converts into voice an electrical signal fed from the baseband block 3 and amplified by an amplifier circuit 5. A microphone 6 serves as a mouthpiece, to which the user speaks during a call. The microphone 6 converts the voice fed thereto into an electrical signal. An amplifier circuit 7 amplifies the electrical signal from the microphone 6 and then feeds it to the baseband block 3. A speaker 8 serves as a loudspeaker that permits people around to hear the received voice. The speaker 8 converts into voice the electrical signal fed from the baseband block 3 and amplified by an amplifier circuit 9. The speaker 8 also gives off a ringing tone when a call is received. Here, the amplifier circuits 5, 7, and 9 all have their gains fixed, and therefore the received voice volume and the microphone sensitivity cannot be adjusted by varying the gains of those amplifier circuits. As described above, the received voice volume and the microphone sensitivity are adjusted by the audio codec 32 provided in the baseband block 3. A switching circuit 10 controls the connection (turning on and off) of the amplifier circuits 5, 7, and 9 to the baseband block 3 according to instructions from the control circuit 11, which will be described below.

The control circuit 11 includes a microprocessor, and controls the individual blocks provided in the mobile telephone device according to an operation program stored in a ROM (read-only memory) 12. A RAM (random-access memory) is used to store information needed for the operation of the control circuit 11. A display 14 includes a liquid crystal display or the like, and displays the telephone number of a call originator and other information. An input block 15 includes a numerical key pad 151 for entering a telephone number and the like, an off-hook key 152 for starting a call, an on-hook key 153 for ending a call, and a power key 154 for turning on an off the power.

A GPS receiver 16 receives through a GPS antenna 17 a radio wave indicating the current location. The GPS receiver 16 converts the received radio wave into an electrical signal and then feeds it to the control circuit 11. A direction sensor 18 detects the bearing of the mobile telephone device on an absolute basis by exploiting the earth's magnetism.

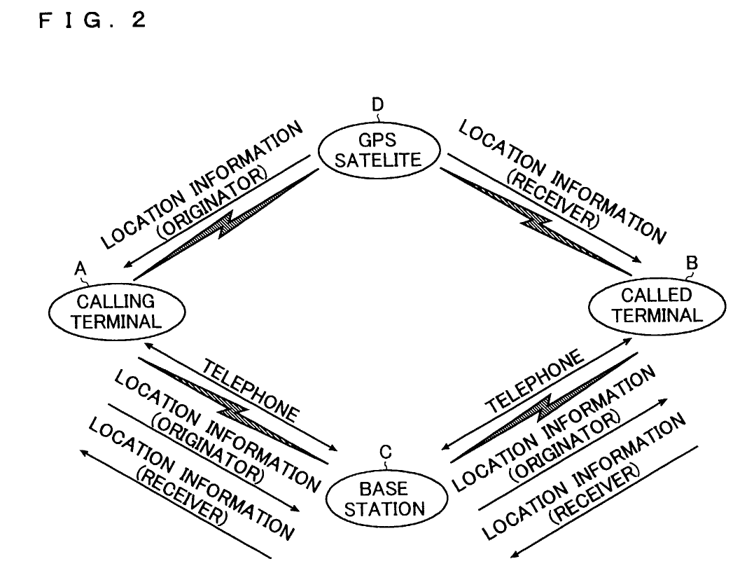

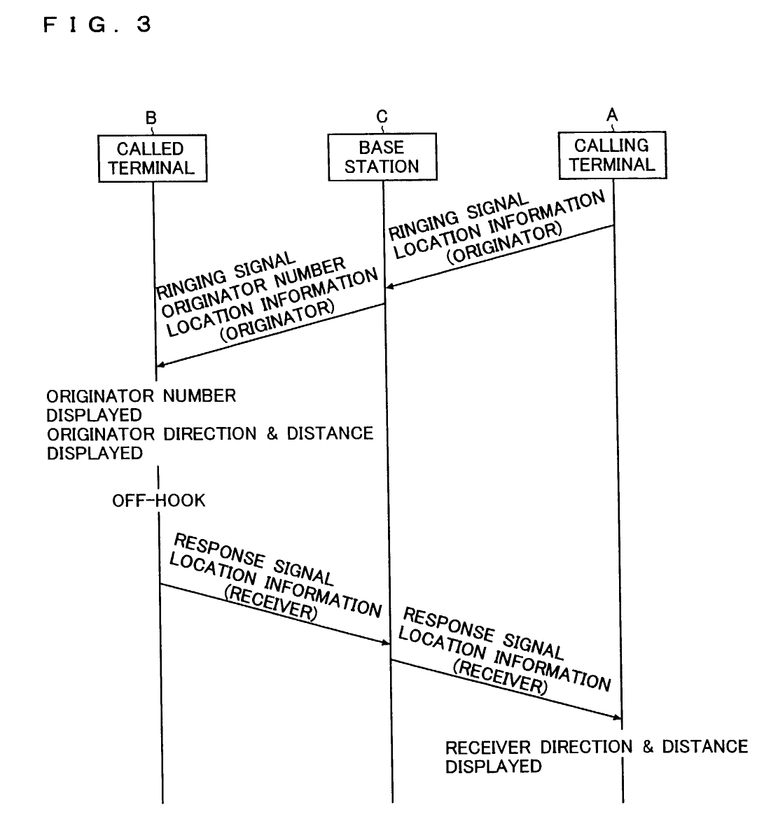

Next, how the information on the current location of a call originator is displayed on the mobile telephone device of a call receiver will be described. FIG. 2 is a diagram showing a communications system in which the embodiment under discussion operates. This figure shows a communications system comprising a call originator's mobile telephone device (hereinafter called the calling terminal A), a call receiver's mobile telephone device (hereinafter called the called terminal B), a base station C for those mobile telephone devices, and a GPS satellite D. FIG. 3 is a time chart showing how communication proceeds between the calling terminal A, the called terminal B, and the base station C.

The calling terminal A and the called terminal B receive, from a plurality of GPS satellites, location information that is updated every one minute, then calculate the current locations of the devices themselves, and then store them in their respective RAMs 13. When, in the calling terminal A, the telephone number of the called terminal B is entered by the use of the numerical key pad 151 and then the off-hook key 152 is pressed, the calling terminal A transmits a ringing signal to the base station C to call up the called terminal B. Here, from the calling terminal A to the base station C is transmitted not only the ringing signal but also the information on the current location of the calling terminal A.

The base station C transmits to the called terminal B the ringing signal and the current location information from the calling terminal A along with the telephone number of the call originator. On receiving these, the called terminal B gives off a ringing tone from the speaker 8 and displays the telephone number of the call originator on the display 14. Moreover, the called terminal B, based on its own current location information and the received current location information of the calling terminal A, calculates the distance and direction from the called terminal B to the calling terminal A, and displays the calculated direction and distance of the calling terminal A on the display 14 against a background that coincides with the bearing detected by the direction sensor 18. Examples of the display shown on the display 14 will be described in detail later.

In this way, by displaying not only the telephone number of the call originator but also its current location information in the area for displayed information (i.e., additional information such as the telephone number of the call originator), it is possible to transmit the current location information of the calling terminal A to the called terminal B before the called terminal B responds to a call. This permits a call receiver to decide whether to respond to a call or not after identifying the current location of a call originator, and thus eliminates the need to respond to an incoming call when communication using a mobile telephone device is unnecessary as when a call originator is nearby a call receiver or at home.

In this state, when the off-hook key 152 of the called terminal B is pressed, the called terminal B is brought into an off-hook state. At this point, from the called terminal B to the base station C is transmitted, along with a response signal in response to the ringing signal, the current location information of the called terminal B. On receiving these, the base station C transmits to the calling terminal A the response signal and the current location information of the called terminal B. On receiving the current location information of the called terminal B, the calling terminal A, based on its own current location information and the received current location information of the called terminal B, calculates the distance and direction from the calling terminal A to the called terminal B, and displays the calculated direction and distance of the calling terminal B on the display 14 against a background that coincides with the bearing detected by the direction sensor 18.

In this way, by displaying current location information in the area for displayed information (i.e., additional information such as the telephone number of the call originator), it is possible to transmit the current location information of the called terminal B to the calling terminal A during a call. Thus, with the mobile telephone device of this embodiment, it is possible not only to notify a call receiver of the location of a call originator, but also to notify the call originator of the location of the call receiver; that is, communication partners can know the location of each other.

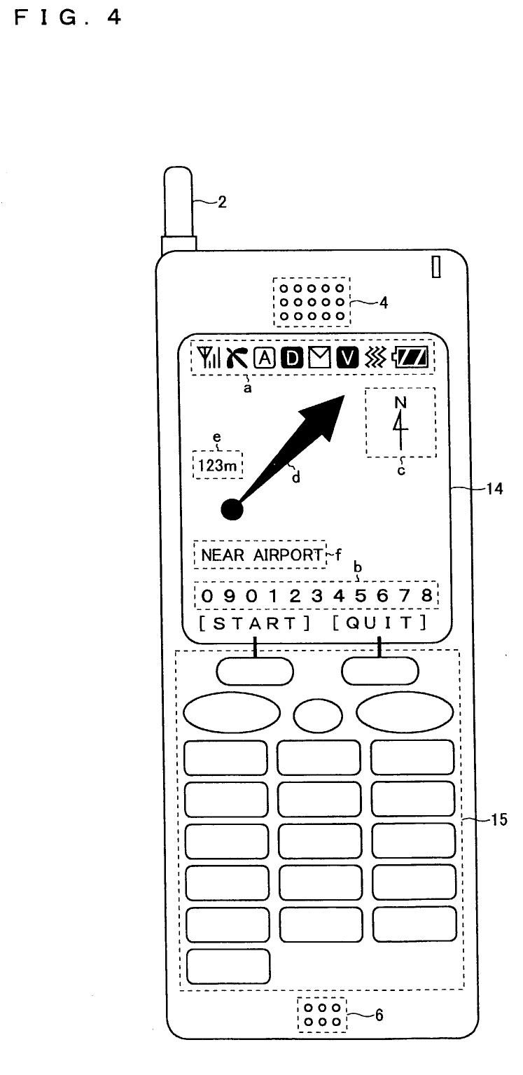

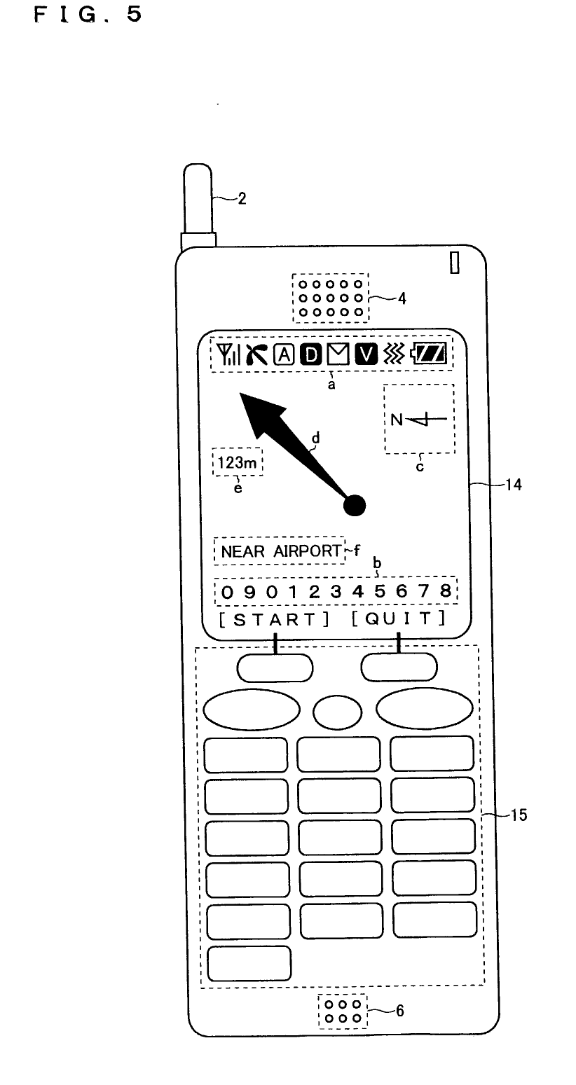

Next, what is displayed as location information on the display 14 will be described in detail with reference to FIGS. 4 and 5. FIGS. 4 and 5 are diagrams showing examples of what is displayed on the display 14. As shown in these figures, in the mobile telephone device of this embodiment, when the current location information of a communication partner is shown, on the display 14 are displayed, in addition to various icons “a” indicating the status (radio wave strength, remaining battery power, etc.) of the mobile telephone device and the telephone number “b” of the communication partner, a compass “c” indicating the absolute direction (relative to the earth) of the mobile telephone device itself, an arrow “d” indicating the direction of the communication partner relative to the mobile telephone device, a counter “e” indicating the distance from the mobile telephone device to the communication partner, and a landmark “f” indicating the name of the place corresponding to or any other word or words associated with the current location of the communication partner.

In this way, by indicating the direction of a communication partner relative to the mobile telephone device with an arrow “d,” it is possible to indicate the direction of the communication partner in an easy-to-grasp way even when the display 14 is small. In addition, there is no need to provide a memory for the storage of maps. Thus, this configuration is very suitable for mobile telephone devices, in which smallness, thinness, and lightness count.

Moreover, as described above, in the mobile telephone device of this embodiment, on the display 14 are displayed the direction (arrow “d”) and distance (counter “e”) of the called terminal B and the landmark “f” against a background that coincides with the bearing (compass “c”) detected by the direction sensor 18. Specifically, when the user is holding the mobile telephone device with its top pointing to the north, and the current location information of a communication partner located to the northeast is being displayed, the arrow “d” points to the upper right on the display 14 (see FIG. 4). When, from this state, the user turns the mobile telephone device so that its top points to the east, the arrow “d” turns to point to the upper left on the display 14 (see FIG. 5). In this way, the mobile telephone device of this embodiment indicates to the user the absolute direction and distance of a communication partner irrespective of the bearing of the mobile telephone device, and thereby permits the user to readily grasp the current location of the communication partner.

It is to be understood that the contents and format of the location information displayed on the display 14 are not limited to those specifically described above. For example, in a case where the current location information indicated before responding to an incoming call is used only for the purpose of deciding whether to respond to the call or not, it is possible to display only the distance counter “e” or the landmark “f” without displaying the arrow “d.” Alternatively, it is also possible, as conventionally practiced, to display the current location of a call originator by superimposing a point indicating it on a map.

Although the embodiment described above deals with a case where the current location information of the mobile telephone device itself is detected by means of a GPS, its detection may be achieved by any other means. For example, it is also possible to acquire the current location information of the mobile telephone device itself by receiving it from base stations or beacons located nearby.

Although the embodiment described above deals with a case where the distance to a communication partner is indicated visually by the use of a distance counter “e,” its indication may be achieved in any other manner. For example, it is also possible to indicate the distance to a communication partner in the form of voice.

What is claimed is:

1. A mobile telephone device comprising:
a communicator for controlling origination and reception of a call to and from a communication partner device;
a display for displaying information on a screen;
a location detector for detecting location information of the mobile telephone device itself;
a receiver for receiving location information of the communication partner device;
a direction sensor for detecting a bearing of the mobile telephone device; and
a direction calculator for calculating a direction of the communication partner device relative to the mobile telephone device based on the location information of the mobile telephone device and of the communication partner device,
wherein the direction of the communication partner device relative to the mobile telephone device is displayed on the display against a background coinciding with the bearing detected by the direction sensor.

2. A mobile telephone device as claimed in claim 1, further comprising:
a distance calculator for calculating a distance from the mobile telephone device to the communication partner device based on the location information of the mobile telephone device and of the communication partner device,
wherein the distance from the mobile telephone device to the communication partner device is displayed on the display

3. A mobile telephone device as claimed in claim 1, further comprising:
distance calculator for calculating a distance from the mobile telephone device to the communication partner device based on the location information of the mobile telephone device and of the communication partner device,
a speaker for outputting information in a form of voice,
wherein the distance from the mobile telephone device to the communication partner device is indicated in a form of voice output from the speaker.

4. A mobile telephone device as claimed in claim 1,
wherein the mobile telephone device displays a name of a place corresponding to or any other word or words associated with the location information of the communication partner device.

5. A mobile telephone device as claimed in claim 1, further comprising:
a transmitter for transmitting the location information of the mobile telephone device to the communication partner device,
wherein the location information of the mobile telephone device is transmitted to the communication partner device irrespective of whether the mobile telephone device is a call originator or call receiver.

6. A mobile telephone device as claimed in claim 1,
wherein the location detector has a GPS receiver.

7. A mobile telephone device comprising:
a communicator for controlling origination and reception of a call to and from a communication partner device;
a receiver for receiving location information of the communication partner device when the mobile telephone device receives a call; and
an indicator for indicating information,
wherein the indicator indicates the location information of the communication partner device before the mobile telephone device responds to the call.

8. A mobile telephone device as claimed in claim 7, further comprising:
a location detector for detecting location information of the mobile telephone device itself;
a distance calculator for calculating a distance from the mobile telephone device to the communication partner device based on the location information of the mobile telephone device and of the communication partner device,
wherein the indicator indicates distance from the mobile telephone device to the communication partner device before the mobile telephone device responds to the call.

9. A mobile telephone device as claimed in claim 8, further comprising:
a direction sensor for detecting a bearing of the mobile telephone device; and
a direction calculator for calculating a direction of the communication partner device relative to the mobile telephone device based on the location information of the mobile telephone device and of the communication partner device,
wherein the indicator is a display that displays information on a screen, and displays the direction of the communication partner device relative to the mobile telephone device against a background coinciding with the bearing detected by the direction sensor before the mobile telephone device responds to the call.

10. A mobile telephone device as claimed in claim 7,
wherein the mobile telephone device indicates, by using the indicator, a name of a place corresponding to or any other word or words associated with the location information of the communication partner device before the mobile telephone device responds to the call.

11. A mobile telephone device as claimed in claim 8,
wherein the location detector has a GPS receiver.

12. A mobile telephone device as claimed in claim 7, further comprising:
a location detector for detecting location information of the mobile telephone device itself; and
a transmitter for transmitting the location information of the mobile telephone device along with a ringing signal when the mobile telephone device originates a call.
